(19) United States
(12) Patent Application Publication
(10) Pub. No.: US 2003/0192047 A1
(43) Pub. Date: Oct. 9, 2003

(54) Exporting data from a digital home communication terminal to a client device

(76) Inventors: Michael A. Gaul, Lawrenceville, GA (US); Samuel H. Russ, Alpharetta, GA (US); David B. Lett, Duluth, GA (US); Jonathan A. Robinson, Norcross, GA (US)

Correspondence Address: SCIENTIFIC-ATLANTA, INC., INTELLECTUAL PROPERTY DEPARTMENT, 5030 SUGARLOAF PARKWAY, LAWRENCEVILLE, GA, 30044, US

(21) Appl. No.: 10/104,921

(22) Filed: Mar. 22, 2002

(51) Int. Cl. G06F 3/00; H04N 5/445; G06F 13/00; H04N 7/173; H04N 7/16

(52) U.S. Cl. 725/39; 725/131; 725/139; 725/151

(57) ABSTRACT

A method for exporting data includes receiving a request for exporting DHCT-related data and then exporting the DHCT-related data from a digital home communication terminal (DHCT) to a client device, wherein the DHCT and the client device are located at a customer premises.

### FIELD OF THE INVENTION

This invention relates in general to television systems, and more particularly, to the field of subscriber television systems.

### DESCRIPTION OF THE RELATED ART

Cable television systems are now capable of providing many services in addition to analog broadcast video. In implementing enhanced programming, the home communication terminal (“HCT”), otherwise known as the settop box, has become an important computing device for accessing various video services. In addition to supporting traditional analog broadcast video functionality, digital HCTs (or “DHCTs”) now also support an increasing number of two-way digital services such as video-on-demand.

A DHCT is typically connected to a cable or satellite television network and includes hardware and software necessary to provide various services and functionality. Preferably, some of the software executed by a DHCT is downloaded and/or updated via the cable television network. Each DHCT also typically includes a processor, communication components and memory, and is connected to a television

One service that is often offered by a DHCT is an interactive program guide (IPG). An IPG allows viewers (also referred to as “subscribers” or “users”) to interactively browse a television program schedule. One problem with currently available IPGs is that locating desired television program information can require many keystrokes and can consume significant amounts of time, especially where there are hundreds of available television channels. Another problem is that one household member's use of the IPG may interfere with another household member's viewing of a television program. Yet another problem is that users may be distracted by unwanted television program information contained in an IPG. As a result, there is a need for systems and methods for addressing these and other problems associated with DHCT functionality.

### BRIEF DESCRIPTION OF THE DRAWINGS

The invention can be better understood with reference to the following drawings. The components in the drawings are not necessarily drawn to scale, emphasis instead being placed upon clearly illustrating the principles of the present invention. In the drawings, like reference numerals designate corresponding parts throughout the several views.

FIG. 1 is a block diagram depicting a non-limiting example of a subscriber television system.

FIG. 2 is a block diagram depicting a non-limiting example of the internal configuration of the DHCT depicted in FIG. 1.

FIG. 3 is a block diagram depicting a non-limiting example of the internal configuration of the headend depicted in FIG. 1.

FIG. 4 depicts a non-limiting example of a remote control device that may be used to provide user input to the DHCT depicted in FIG. 2.

FIG. 5 depicts a non-limiting example of an interactive program guide (IPG) that may be presented by the DHCT depicted in FIG. 2.

FIG. 6 depicts a non-limiting example of a Channel Scope screen that may be presented to a user in response to the activation of a “C” key depicted in FIG. 4 while a user is being presented with the Channel Scope screen depicted in FIG. 5.

FIG. 7 depicts a non-limiting example of a Channel Limitations screen that may be presented to a user in response to the selection of the option to export IPG data related to a limited number of channels depicted in FIG. 6.

FIG. 8 depicts a non-limiting example of a channel type selection screen that may be presented to a user in response to the selection of the channel type option depicted in FIG. 7.

FIG. 9 depicts a non-limiting example of a Export Frequency screen that may be presented to a user in response to the selection of one or more IPG data limitations such as, for example, an IPG channel type option from the IPG channel type menu depicted in FIG. 8.

FIG. 10 depicts a non-limiting example of a day selection screen that may be presented to a user in response to the selection of the “export IPG data on a regular basis” option from the export frequency screen depicted in FIG. 9.

FIG. 11 depicts a non-limiting example of an export time selection screen that may be presented to a user in response to the selection of an option from the day selection screen depicted in FIG. 10.

FIG. 12 depicts a non-limiting example of a scope of data selection screen that may be presented to a user in response to the selection of a data export time via the export time selection screen depicted in FIG. 1, or in response to the selection of the “only export IPG data now” option depicted in FIG. 9.

FIG. 13 depicts a non-limiting example of an hour selection screen that may be presented to a user in response to the selection of a scope of data option via the scope of data selection screen depicted in FIG. 12.

FIG. 14 depicts a non-limiting example of a program type selection screen that may be presented to a user in response to the selection of the program type option depicted in FIG. 7.

FIG. 15 depicts a non-limiting example of a channel selection screen that may be presented to a user in response to the selection of the channel identity option depicted in FIG. 7.

FIG. 16 is a block diagram depicting a non-limiting example of a client device that can be used to import data from the DHCT depicted in FIG. 1.

FIG. 17 depicts a non-limiting example of an IPG data import screen that may be presented by the client device depicted in FIG. 16.

FIG. 18A depicts a data export method for exporting data to the client device depicted in FIG. 1.

FIG. 18B depicts another data export method for exporting data to the client device depicted in FIG. 1.

### DETAILED DESCRIPTION OF THE PREFERRED EMBODIMENTS

In one embodiment of the invention, a digital home communication terminal (DHCT) receives a request for certain data from a client device and then exports the requested data to the client device. In another embodiment of the invention, a DHCT receives user input requesting that certain data be exported to a client device. The user input may be provided via, for example, a remote control device. After receiving the user input, the DHCT exports the requested data to the client device. The exported data may comprise, for example, a schedule of television presentations that are broadcast to the DHCT. If the client device is a personal computer, then it can be used to display, sort, rearrange, browse through, search, filter, format, and/or initiate the printing of the data received from the DHCT.

The preferred embodiments of the present invention now will be described more fully hereinafter with reference to the accompanying drawings. These embodiments are examples, among others, of systems and methods of the present invention. Therefore, the present invention, which may be embodied in many different forms, should not be construed as limited to the embodiments set forth herein.

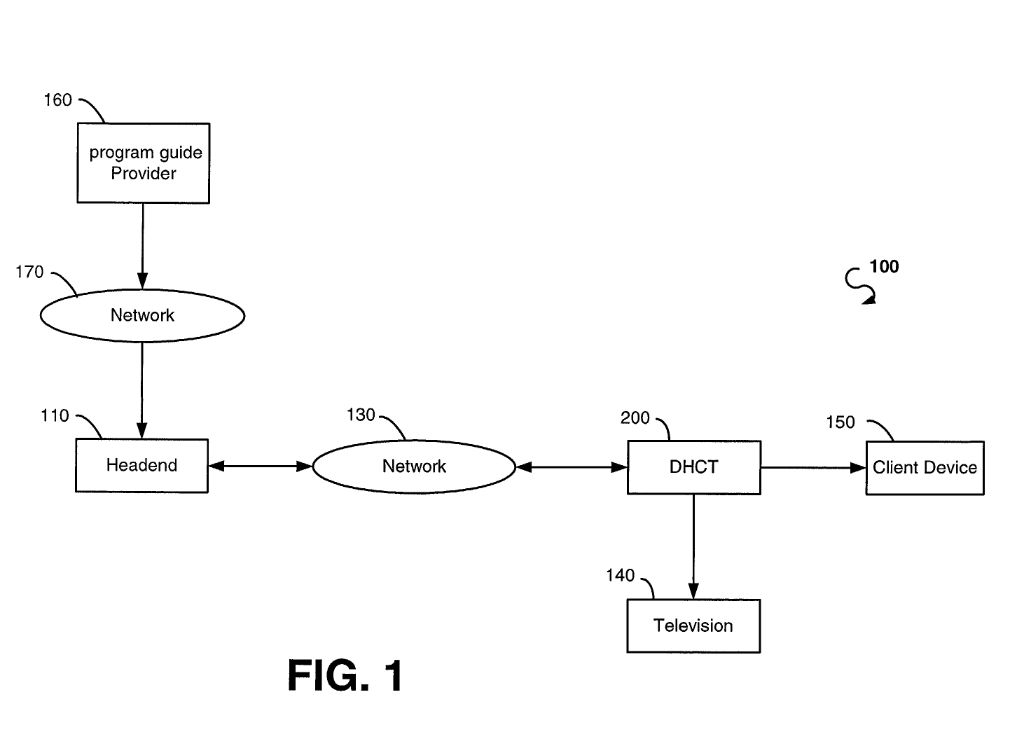

FIG. 1 is a block diagram depicting a non-limiting example of a subscriber television system (STS) 100. In this example, the STS 100 includes a headend 110 and a DHCT 200 that are coupled via a subscriber television network 130. The DHCT 200 is typically situated at a customer's premises, and may be a stand-alone unit or integrated into another device such as, for example, a television 140. The customer's premises may be a user's residence or place of business. The DHCT 200 receives signals (video, audio and/or other data) from the headend 110 through the network 130 and provides any reverse information to the headend 110 through the network 130. The network 130 may be any suitable means for communicating television services data including, for example, a cable television network or a satellite communication network.

The headend 110 receives program guide data from a program guide provider 160 via a network 170. The program guide data comprises information about services that may be provided via the DHCT 200. The network 170 is preferably the Internet but may be any wired or wireless network through which the program guide data may be transmitted to the headend 110. The headend then edits the program guide data and transmits the edited program guide data to the DHCT 200 via the network 130, as will be discussed in more detail below. The headend 110 may include one or more server devices (not shown) for providing video, audio, and textual data to client devices such as DHCT 200. The headend 110 and the DHCT 200 cooperate to provide a user with television services via the television 140. The television services may include, for example, broadcast television services, cable television services, premium television services, video-on-demand (VOD) services, and/or pay-per-view (PPV) services.

The DHCT 200 is configured to export DHCT-related data to a client device 150. As used herein “exporting” includes data in a way that preserves its intrinsic meaning. Exporting data is different than “rendering” data. For example text-based data, also known as character-based data, may be “exported” to a computer where it may be further manipulated by being sorted or searched. Furthermore, the interface by which the user of the client device 150 queries and/or views the exported data may be easily customized. For example, a device with a smaller display screen may be configured to show fewer words or data entries. In contrast, bitmap data is “rendered” as an image via a display device such as, for example, a television. A rendered image is typically incapable of being sorted, searched, or customized based on its content.

DHCT-related data that is exported by the DHCT 200 comprises information that is related to one or more services provided by the DHCT 200. Therefore, the DHCT-related data may include, for example, television program guide information or subscriber billing information. In one embodiment of the invention, the DHCT-related data is exported as text-based data. Text-based data, also known as character-based data, may be displayed as a set of predefined characters. Non-limiting examples of text-based data includes data that is in an ASCII format, a word processing format, a spreadsheet format, an HTML format, or a database format.

In one embodiment of the invention, exported DHCT-related data comprises data that is specific to the DHCT 200 that is exporting the data. Therefore, DHCT-related data that may be exported by one DHCT 200 may not be exported by certain other DHCTs. For example, if the exported DHCT-related data contains program guide information, then such program guide information may vary based upon several factors including:

a) a user's geographical location;

b) the scope of a user's television services subscription (e.g., basic vs. premium);

c) the television services that a household member is authorized to receive (e.g., based on parental control);

d) the television services that the DHCT 200 is capable of providing (as may be identified by a DHCT model number); and/or

e) the video presentations that may be stored in the DHCT 200 and that may be included in an interactive program guide.

DHCT-related data may be exported by the DHCT 200 to the client device 150 either automatically, such as at a predetermined time, or in response to a contemporary request from a user or from the client device 150. The client device 150 may be any device that is capable of receiving the DHCT-related data, including, for example, a personal computer, a printer, or a personal digital assistant (PDA).

If the client device 150 is a personal computer, then the user may use the client device 150 to display, sort, rearrange, browse through, search, and/or initiate the printing of any imported DHCT-related data. Although it is known in the art for a computer to download program guide data from an Internet site, doing so requires an Internet connection. Generally, Internet connections are provided only via a paid subscription which may cost the subscriber a significant monthly fee over and above the cost of subscriber television services. Furthermore, many Internet connections can be relatively slow, especially during heavy traffic time periods. Still another disadvantage of downloading program guide data from an online service over the Internet is that the downloaded information may not be as reliable as that provided by a television service provider. Since the television service provider provides both the television presentations and related program guide data, the television service provider is more likely to provide more up-to-date and accurate program guide data. Furthermore, a user may be more comfortable and accustomed to viewing program guide data that is configured in the same manner as provided by the user's television service provider. One of ordinary skill in the art will appreciate, from the foregoing description, that receiving program guide data by a client device 150 directly from the DHCT 200, as provided by an embodiment of the present invention, is likely to be less expensive and faster while providing more accurate and up-to-date information.

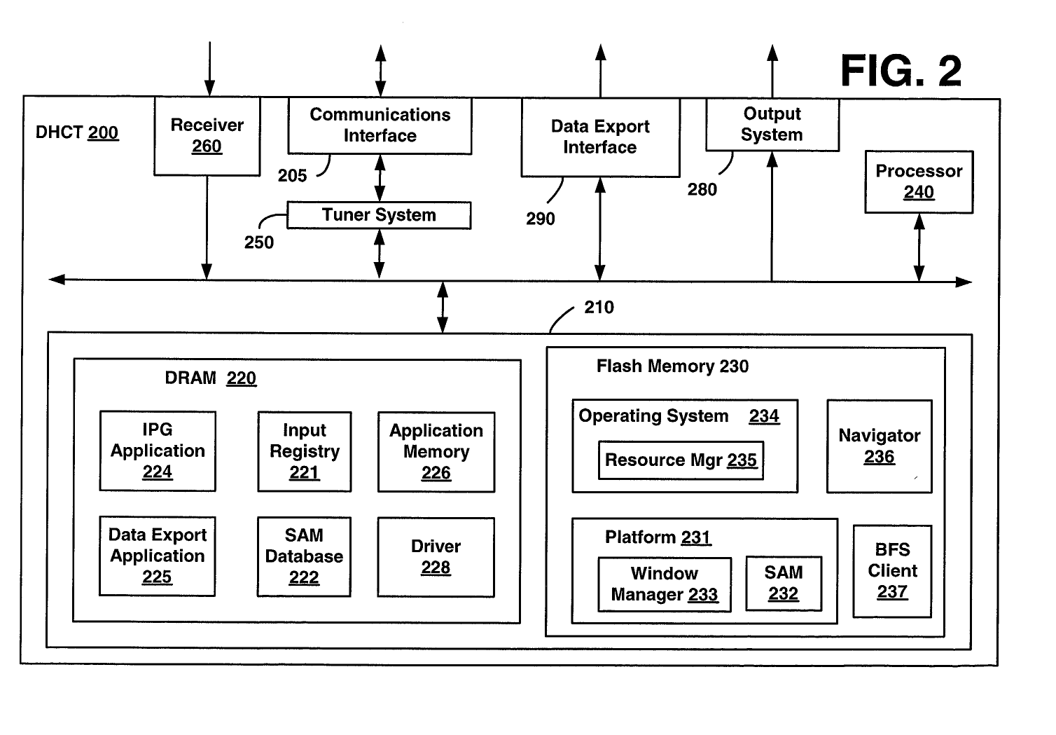

FIG. 2 is a block diagram depicting a non-limiting example of a DHCT 200. The DHCT 200 described herein is merely illustrative and should not be construed as implying any limitations upon the scope of the present invention. The DHCT 200 includes a communications interface 205 for receiving signals (video, audio and/or other data) from the headend 110, at least one processor 240 for controlling operations of the DHCT 200, an output system 280 for driving the television 140, and a tuner system 250 for tuning to a particular television service to be displayed. The tuner system 250 includes, in one implementation, an out-of-band tuner for bi-directional quadrature phase shift keying (QPSK) data communication and a quadrature amplitude modulation (QAM) tuner for receiving television signals. A receiver 260 receives externally-generated user inputs or commands from an input device such as, for example, a remote control device.

A data export interface 290 is used for exporting DHCT-related data to a client device 150. The data export interface may comprise, for example, among others, a USB (Universal Serial Bus), an Ethernet port (for connection to a computer), an IEEE-1394 connection, a serial port, a parallel port, a wireless radio frequency (RF) interface, and/or an infra-red (IR) interface. In one possible implementation, the data export interface 290 may be coupled to a client device via an Ethernet hub.

DHCT-related data may be transmitted from the DHCT 200 to the client device 150 using an appropriate protocol such as, for example, Simple Network Management Protocol (SNMP), Hyper Text Transfer Protocol (HTTP), File Transfer Protocol (FTP), or any other protocol that may be compatible with the client device 150. Data that is exported using SNMP may be configured into a Management Information Base (MIB) format comprising a set of related managed objects that are differentiated by unique codes. The following table contains sample descriptions for a number of IPG objects using MIB description syntax:

TABLE 1
examples of IPG objects that are managed using MIB description syntax

| OBJECT TYPE | SYNTAX | DESCRIPTION |
|---|---|---|
| vIPGChanCount | Integer32 | The number of channels supported by this |
| | | DHCT on this DBDS. Note that actual |
| | | channels are usually not assigned |
| | | consecutively, so this does not represent |
| | | the highest channel number. |
| vIPGChanTable | SEQUENCE OF | Channel Table: one entry for each channel |
| | vIPGChanEntry | that the DHCT/DBDS supports. May |
| | | include premium channels that could be |
| | | available but are not available to the |
| | | present subscriber. |
| vIPGChanEntry | vIPGChanEntry | An entry containing formation about each |
| | | channel |
| vIPGChanNumber | Integer 32 | The channel number: the number used to |
| | | select this channel via the remote control |
| vIPGChanStatus | INTEGER | Indicates the availability of this channel to |
| | | this subscriber at this time. Authorized |
| | | (1) indicates that the subscriber may view |
| | | the channel. Denied(2) indicates that he is |
| | | not authorized to do so (e.g., a premium |
| | | channel that the subscriber did not order). |
| | | OutOfService(3) indicates that the |
| | | channel is temporarily not available for |
| | | other reasons. |
| vIPGChanAbbr | DisplayString (SIZE | An abbreviation for the name of the |
| | (0..5)) | channel |
| vIPGChanName | DisplayString (SIZE | The full name of the channel |
| | (0..32)) | |
| vIPGDaysAvailable | Integer 32 | Number of days of program guide |
| | | information available (including today). |
| vIPGGuideTable | SEQUENCE OF | Program guide Table: Indicates the |
| | vIPGGuideEntry | programming content to be found for each |
| | | supported channel, on any day for which |
| | | guide information is available, at any |
| | | time. |
| vIPGGuideEntry | vIPGGuideEntry | An entry containing information about a |
| | | particular program, where the channel, |
| | | day, and time are the indices. |
| vIPGGuideDay | Integer32 | The day on which this program begins, |
| | | relative to the present day which is |
| | | denoted 1. Tomorrow is denoted 2, and |
| | | so on. |
| vIPGGuideChan | Integer32 | The channel number on which this |
| | | program appears, using the same |
| | | numbering convention as |
| | | vIPGChanNumber described above. |
| vIPGGuideTime | Integer32 | The time at which this program starts, |
| | | measured in minutes relative to midnight |
| | | at the start of the day on which the |
| | | program starts. |
| vIPGGuideLength | Integer32 | The duration of the program in minutes. |
| vIPGGuideTShort | DisplayString | A short program title |
| | (SIZE (0..16)) | |
| vIPGGuideTLong | DisplayString | A long program title |
| | (SIZE (0..127)) | |
| vIPGGuideTheme | INTEGER | A category for this program |
| | Other(0) | |
| | ActionAdventure(1) | |
| | Adult(2) | |
| | Biography(3) | |
| | Cartoons(4) | |
| | Children(5) | |
| | Comedy(6) | |
| | Documentary(7) | |
| | Drama(8) | |
| | Family(9) | |
| | Fitness(10) | |
| | GameShows(11) | |
| | History(12) | |
| | Horror(13) | |
| | Instructional(14) | |
| | Movies(15) | |
| | Music(16) | |
| | MysterySuspense(17) | |
| | Nature(18) | |
| | News(19) | |
| | Performance(20) | |
| | Reality(21) | |
| | Religious(22) | |
| | Romance(23) | |
| | SciFi(24) | |
| | SoapOpera(25) | |
| | Sports(26) | |
| | Baseball(27) | |
| | Basketball(28) | |
| | Football(29) | |
| | Golf(30) | |
| | Hockey(31) | |
| | Racing(32) | |
| | Soccer(33) | |
| | TalkShows(34) | |
| | Variety(35) | |
| | Western(36) | |
| vIPGGuideDShort | DisplayString | Short description of the program |
| | SIZE (0..100)) | |
| vIPGGuideDLong | DisplayString | Detailed description of the program |
| | (SIZE (0..500)) | |
| vIPGGuideMPAA | DisplayString | MPAA Rating: e.g., MPAAG, MPAAPG, |
| | (SIZE (0..16)) | MPAAPG 14 . . . |
| vIPGGuideRate | DisplayString | V-Chip rating, e.g., TVY, TVY7, |
| | (SIZE (0..16)) | TVPG . . . |
| vIPGGuideFeatures | Integer32 | A bit-map describing several qualities of |
| | | the program. Used with |
| | | vIPGGuideFmask. If a bit is set in |
| | | vIPGGuideFmask, the corresponding |
| | | quality valid in vIPGGuideFeatures, |
| | | otherwise it is considered unspecified. If |
| | | the bit is also set in vIPGGuideFeatures, |
| | | the quality is present. Bit positions are: |
| | | 0 - Stereo |
| | | 1 - Surround Sound |
| | | 2 - SAP included |
| | | 3 - Closed Captioned |
| | | 4 - Animated |
| | | 5 - Black and White |
| | | 6 - Rerun |
| | | 7 - Live |
| | | 8 - Movie |
| | | 9 - Nudity |
| | | 10 - Adult Language |
| | | 11 - Violence |
| | | 12 - Adult Themes |
| vIPGGuideFmask | Integer32 | (See vIPGGuideFeatures above) |
| vIPGGuideHalfs | Integer32 | If program contains a critique, the number |
| | | of half-stars for the program, plus 1. For |
| | | example: |
| | | 0=no critique |
| | | 1=half-star |
| | | 2=one star (and so on). |

In one embodiment of the invention, the DHCT 200 receives data in a first format from the headend 110, and then exports the data to the client device 150 in a second format that is compatible with the client device 150. If the client device 150 includes a browser that is capable of reading HTML documents, then IPG data may be exported to the client device 150 in an HTML format. The following is an example of IPG data in an HTML format:

<table border=>

<tr><td>FOOD</td><td>35</td><td>11282000</td><td>0700</td><td>30</td><td>Martha's Kit.</td><td>From Martha's Kitchen</td><td>14</td><td>Christmas fruitcake; chocolate kiss cookie.</td><td>“Christmas Baking.” Christmas fruitcake; chocolate kiss cookie. (30 minutes) Cooking How-to </td><td></td><td></td><td>N</td><td>N</td><td>N</td><td>N</td><td>N</td><td>N</td><td>N</td><td>N</td><td>N</td><td>N</td><td>N</td><td>N</td><td>N</td><td></td></tr>

<tr><td>FOOD</td><td>35</td><td>11282000</td><td>0730</td><td>30</td><td>Hot off Grill</td><td>Hot off the Grill With Bobby Flay</td><td>14</td><td>Skewered lamb with Rioja-red wine vinaigrette and endive salad.</td><td>“Skewered Lamb.” Skewered lamb with Rioja-red wine vinaigrette and endive salad. (30 minutes) Cooking How-to </td><td></td><td></td><td>N</td><td>N</td><td>N</td><td>N</td><td>N</td><td>N</td><td>N</td><td>N</td><td>N</td><td>N</td><td>N</td><td>N</td><td>N</td><td></td></tr><tr>

<td>FOOD</td><td>35</td><td>11282000</td><td>0800</td><td>30</td><td>Molto Mario</td><td>Molto Mario</td><td>14</td><td>Funghi di bosco; strozzapretti alla bosciola; puntine con polenta.</td><td>“Foraging in the Modena Hills.” Funghi di bosco; strozzapretti alla bosciola; puntine con polenta. (30 minutes) Cooking How-to </td><td></td><td></td><td>N</td><td>N</td><td>N</td><td>N</td><td>N</td><td>N</td><td>N</td><td>N</td><td>N</td><td>N</td><td>N</td><td>N</td><td>N</td><td></td></tr><tr><td>FOOD</td><td>35</td><td>11282000</td><td>0830</td><td>30</td><td>East Meets</td><td>East Meets West</td><td>0</td><td>Turkey/herb soup with corn-stuffing fritters; turkey Reuben melts; cranberry creme brulee. </td><td>“Thanksgiving Leftovers.” Turkey/herb soup with corn-stuffing fritters; turkey Reuben melts; cranberry creme brulee. (30 minutes) Cooking</td><td></td><td></td><td>N</td><td>N</td><td>N</td><td>N</td><td>N</td><td>N</td><td>N</td><td>N</td>

<td>N</td><td>N</td><td>N</td><td>N</td><td>N</td><td></td></tr><tr><td>FOOD</td><td>35</td><td>11282000</td><td>0900</td><td>30</td><td>In Food Today</td><td>In Food Today</td><td>10</td><td>Maine seaweed harvest; Central Park foraging.</td><td>“Don't Mess with Mother Nature.” Maine seaweed harvest; Central Park foraging. (30 minutes) Cooking Health </td><td></td><td></td><td>N</td><td>N</td><td>N</td><td>N</td><td>N</td><td>N</td><td>N;td><td>N</td><td>N</td><td>N</td><td>N</td><td>N</td><td>N</td><td></td></tr><tr><td>NICK</td><td>41 </td><td>11222000</td><td>0430</td><td>30</td><td>3's Company</td><td>Three's Company</td><td>6</td><td>Jack and Chrissy are handcuffed together.</td><td>“Handcuffed.” Jack and Chrissy are handcuffed together. Comedy Situation </td><td></td><td></td><td>Y</td><td>Y</td><td>N</td><td>N</td><td>N</td><td>N</td><td>N</td><td>N</td><td>N</td><td>N</td><td>N</td><td>N</td><td>N</td><td></td></tr>

<tr><td>NICK</td><td>41</td><td>11222000</td><td>0500</td><td>30</td><td>All in Family</td><td>All in the Family</td><td>6</td><td>Archie has been missing for 24 hours.</td><td>Carroll O'Connor, Jean Stapleton “Archie Is Missing.” Archie has been missing for 24 hours. (30 minutes) Comedy Situation </td><td></td><td></td><td>Y</td><td>Y</td><td>N</td><td>N</td <td>N</td><td>N</td><td>N</td><td>N</td><td>N</td><td>N</td><td>N</td><td>N</td><td>N</td><td></td></tr><tr><td>NICK</td><td>41</td><td>11222000</td><td>0530</td><td>30</td><td>The Jeffersons</td><td>The Jeffersons</td><td>6</td><td>George suffers from problems in the bedroom.</td><td>Sherman Hemsley, Isabel Sanford “A Bedtime Story.” George suffers from problems in the bedroom. (30 minutes) Comedy Situation </td><td></td><td>TVG</td><td>Y</td><td>Y</td><td>N</td><td>N</td><td>N</td><td>N</td><td>N</td><td>N</td><td>N</td><td>N</td><td>N</td><td>N</td><td>N</td><td></td></td><tr><td>NICK</td><td>41 </td><td>11222000</td><td>0600</td><td>30</td><td>Gilligan Isle</td><td>Gilligan's Island</td><td>6</td><td>An island girl devotes herself to Gilligan.</td><td>Bob Denver, Alan Hale Jr. “Slave Girl.” An island girl devotes herself to Gilligan. (30 minutes) Comedy Situation</td><td></td><td></td><td>Y</td><td>Y</td><td>N</td><td>N</td><td>N</td><td>Y</td><td>N</td><td>N</td><td>N</td><td>N</td><td>N</td><td>N</td><td>N</td><td></td></tr>

</table>

Each IPG record shown above contains some or all of the following program information in the following order: channel name, channel number, presentation date, start time, duration, short title, long title, theme, short program description, long program description, Motion Picture Association of America (MPAA) rating, television rating, stereo sound (Y/N), surround sound (Y/N), second audio program (Y/N), close captioned (Y/N), animated (Y/N), black and white (Y/N), re-run (Y/N), live (Y/N), movie (Y/N), nudity (Y/N), adult language (Y/N), violence (Y/N), adult theme (Y/N), program critique (number of half stars out of a maximum of 10 half stars). Blank fields indicate that the corresponding information is not available, whereas the letters “Y” and “N” are used to mean yes and no, respectively.

System memory 210 includes flash memory 230 and dynamic random access memory (DRAM) 220 for storing various applications, modules and data for execution and use by the processor 240. Basic functionality of the DHCT 200 is provided by an operating system 234 that is primarily stored in flash memory 230. The operating system 234 includes at least one resource manager 235 that provides an interface to and coordination of resources of the DHCT 200 such as, for example, computing resources.

One or more programmed software applications, herein referred to as applications, are executed by utilizing the computing resources in the DHCT 200. Applications stored in flash memory 230 or DRAM 220 are executed by processor 240 under the auspices of the operating system 234. Data required as input by an application is stored in DRAM 220 or flash memory 230 and read by processor 240 as needed during the course of the application's execution. Input data may be data stored in DRAM 220 by a secondary application or other source, either internal or external to the DHCT 200, or possibly anticipated by the application and thus created with the application at the time it was generated as a software application, in which case it is stored in flash memory 230. Data generated by an application is stored in DRAM 220 by processor 240 during the course of the application's execution.

An application referred to as navigator 236 is also resident in flash memory 230 and provides a navigation framework for services provided by the DHCT 200. The navigator 236 registers for and in some cases reserves certain user inputs related to navigational keys such as television channel up/down, last television channel, favorite television channel, etc. The client applications may be resident in flash memory 230 or downloaded into DRAM 220.

The flash memory 230 also contains a platform library 231. The platform library 231 is a collection of utilities useful to applications, such as a timer manager, a compression manager, a configuration manager, an HTML parser, a database manager, a widget toolkit, a string manager, and other utilities (not shown). These utilities are accessed by applications via application programming interfaces (APIs) as necessary so that each application does not have to contain these utilities. Two components of the platform library 231 that are shown in FIG. 2 are a window manager 233 and a service application manager (SAM) client 232.

The window manager 233 provides a mechanism for implementing the sharing of the screen regions and user input. The window manager 233 is also responsible for, as directed by one or more applications, implementing the creation, display, and allocation of the limited DHCT 200 screen resources. Window manager 233 allows multiple applications to share the screen by assigning ownership of screen regions, or windows. Window manager 233 communicates with resource manager 235 to coordinate available resources (such as display memory) among different resource-consuming processes. Such processes may be directly or indirectly invoked by one or more applications.

The window manager 233 also maintains, among other things, a user input registry 221 in DRAM 220 so that when a user enters a key or a command via a remote control device or another input device such as a keyboard or mouse, the user input registry 221 may be accessed to determine which of various applications running on the DHCT 200 should receive data corresponding to the input key and in which order. As an application is executed, it registers a request to receive certain user input keys or commands. When the user presses a key corresponding to one of the commands on the remote control device, the command is received by the receiver 260 and relayed to the processor 240. The processor 240 dispatches the event to the operating system 234 where it is forwarded to the window manager 233. The window manager 233 then accesses the user input registry 221 and routes data corresponding to the incoming command to the appropriate application.

The SAM client 232 is a client component of a client-server pair of components, with the server component being located on the headend 110 (FIG. 1). Application clients can be downloaded into DRAM 220 at the request of the SAM client 232, typically in response to a request by the user or in response to a message from the headend. In this non-limiting example, DRAM 220 contains a data export application 225, a driver application 228, and an interactive program guide (IPG) application 224. The data export application 225 exports data from the DHCT 200 to a client device 150 (FIG. 1) The driver application 228 controls the transmission of a print job to a printer that may be coupled to the DHCT 200. The IPG application 224 provides a user with an interactive program guide containing information about television presentations that are scheduled to be provided by the DHCT 200. It should be clear to one with ordinary skill in the art that these applications are not limiting and merely serve as examples for this present embodiment of the invention. Furthermore, one or more DRAM based applications may, as an alternative embodiment, be resident in flash memory 230. These applications, and others provided by a television services system operator, are software entities for providing services to the user.

In one implementation, applications executing on the DHCT 200 work with the navigator 236 by abiding by several guidelines. First, an application utilizes the SAM client 232 for the provision, activation, and suspension of services. Second, an application shares DHCT 200 resources with other applications and abides by the resource management policies of the SAM client 232, the operating system 234, and the DHCT 200. Third, an application conforms to situations where shared resources are only accessible via the navigator 236. Fourth, when an application loses service authorization while providing a service, the application suspends the service via the SAM client 232 (the navigator 236 will reactivate an individual service application when it later becomes authorized). Finally, an application client is designed to not have access to certain user input keys reserved by the navigator 236 (e.g., power, channel ±, volume ±, etc.).

A broadcast file system (BFS) client 237 has a counterpart BFS server module (not shown) located at the headend 110. The BFS server repeatedly sends data that is received by the BFS client 237 and stored in DRAM 220. The data is sent on a data carousel over a period of time in cyclical repeated manner so that applications on a DHCT 200 can use the data as needed. For example, a BFS server may repeatedly send up-to-date IPG data so that the IPG application 224 is able to provide a user with up-to-date television presentation listings.

Data and software used in providing a DHCT service to a user may be stored in one or more of the following memory resources: a data storage device located at a headend, a data storage device located at a customer premises, a non-volatile memory internal to the DHCT 200, and/or a hard drive internal to the DHCT 200. For example, an executable program or algorithm corresponding to an operating system (OS) component, or to a client platform component, or to a client application (e.g., IPG application 224), or to respective parts thereof, may reside in and/or execute out of DRAM 220 and/or flash memory 230, or may reside in a local storage device connected to DHCT 200 and may be transferred into DRAM 220 for execution. Likewise, data input for an executable program or algorithm may reside in DRAM 220 or in flash memory 230, or may reside in a local storage device connected to the DHCT 200 and may be transferred into DRAM 220 for use by an executable program or algorithm. In addition, data output by an executable program or algorithm may be written into DRAM 220 by the executable program or algorithm and may be transferred to flash memory 230 or to a local storage device for storage purposes.

Each of the above mentioned applications comprises executable instructions for implementing logical functions and can be embodied in any computer-readable medium for use by or in connection with an instruction execution system, apparatus, or device, such as a computer-based system, processor-containing system, or other system that can fetch and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner, and then stored in a computer memory.

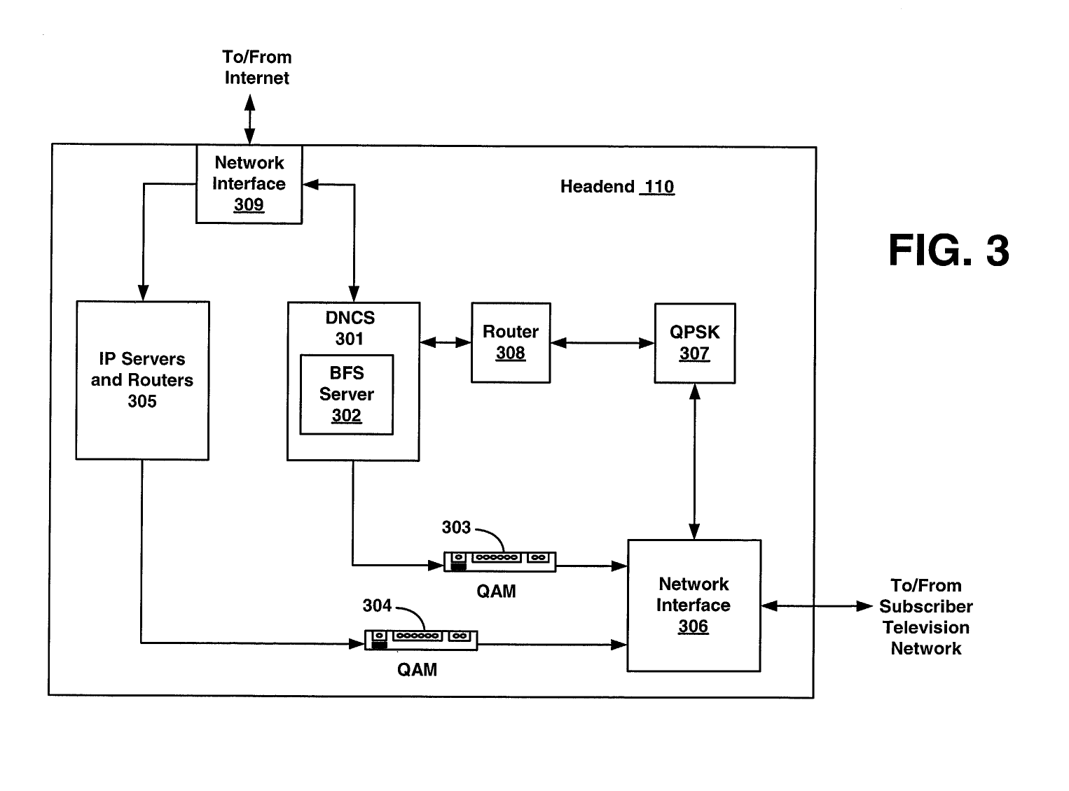

FIG. 3 depicts a non-limiting example of selected components of a headend 110 that is configured in accordance with one embodiment of the present invention. A digital network control system (DNCS) 301 provides management, monitoring, and control of the network's elements and of the broadcast services provided to users. A program guide provider 160 transmits data for television program guides to the DNCS 301 via network 170 (FIG. 1) using a file transfer protocol (FTP). The DNCS 301 includes a “channel map” that defines relationships between channel names listed in the program guide data received from the program guide provider 160 and the numbered channels that are available via the DHCT 200. The channel map is used by the DNCS 301 to edit the program guide data to include channel numbers that correspond to the listed channel names. After the program guide data is edited by the DNCS 301, it is transmitted to the DHCT 200 using the broadcast file system (BFS) server 302. The BFS server 302 and its counterpart, a BFS client module 237 (FIG. 2), are part of a file broadcasting system. The BFS server 302 repeatedly sends data to the DHCT 200 via a quadrature amplitude modulation (QAM) modem 303 over a period of time in a cyclical manner so that the DHCT 200 may access the data as needed.

A quadrature phase shift keying (QPSK) modem 307 is responsible for transporting the out-of-band IP (internet protocol) datagram traffic between the distribution headend 110 and a DHCT 200. Data transmitted or received by the QPSK modem 307 may be routed by a headend router 308. The headend router 308 may be used to deliver upstream data to the various server applications (not shown).

The headend 110 may also provide the DHCT 200 with internet access via internet protocol (IP) servers and routers 305. The IP servers and routers 305 receive data from the Internet via network interface 309 and transmit the data to the DHCT 200 via a QAM 304. The QAM 304 is coupled to the IP servers and routers 305 and to the subscriber television network interface 306. Unlike the DNCS 301, the servers and routers 305 do not edit the information contained in the data received via the Internet.

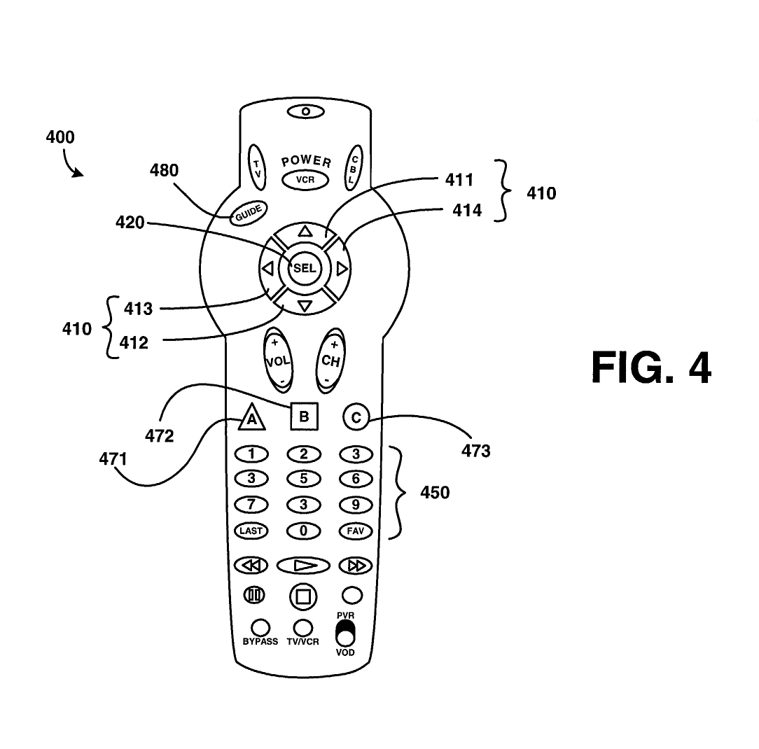

FIG. 4 depicts a non-limiting example of a remote control device 400 that may be used to provide user input to the DHCT 200. The remote control device 400 described herein is merely illustrative and should not be construed as implying any limitations upon the scope of the present invention. Four arrow keys 410 are provided including an up arrow key 411, a down arrow key 412, a left arrow key 413, and a right arrow key 414. The arrow keys 410 can be used to scroll through on-screen options and/or to highlight an on-screen option, whereas the select key 420 may be used to select a currently highlighted option. The guide key 480 may be used to access a television program guide such as, for example, IPG 400 (FIG. 4). The function of the “A” key 471, the “B” key 472, and the “C” key 473 varies depending on the screen being presented to a user at the time of a key's activation. In one embodiment, the “A” key 471 can be used to access a browse-by list for requesting an IPG screen that contains a subset of television presentation listings falling under a user selected browse-by category such as, for example, comedy, drama, action/adventure, sports, etc.; the “B” key 472 can be used to request an IPG screen containing service listings for a user selected date; and the “C” key 473 can be used to request that IPG data be exported to a client device 150.

In an alternative embodiment of the invention, different and/or additional systems and methods of providing user input may be used including, for example, a remote control device having different keys and/or key layouts, a keyboard device, a mouse, a voice activated input system, a touch-screen display, etc. The invention described herein is not limited by the type of device used to provide user input.

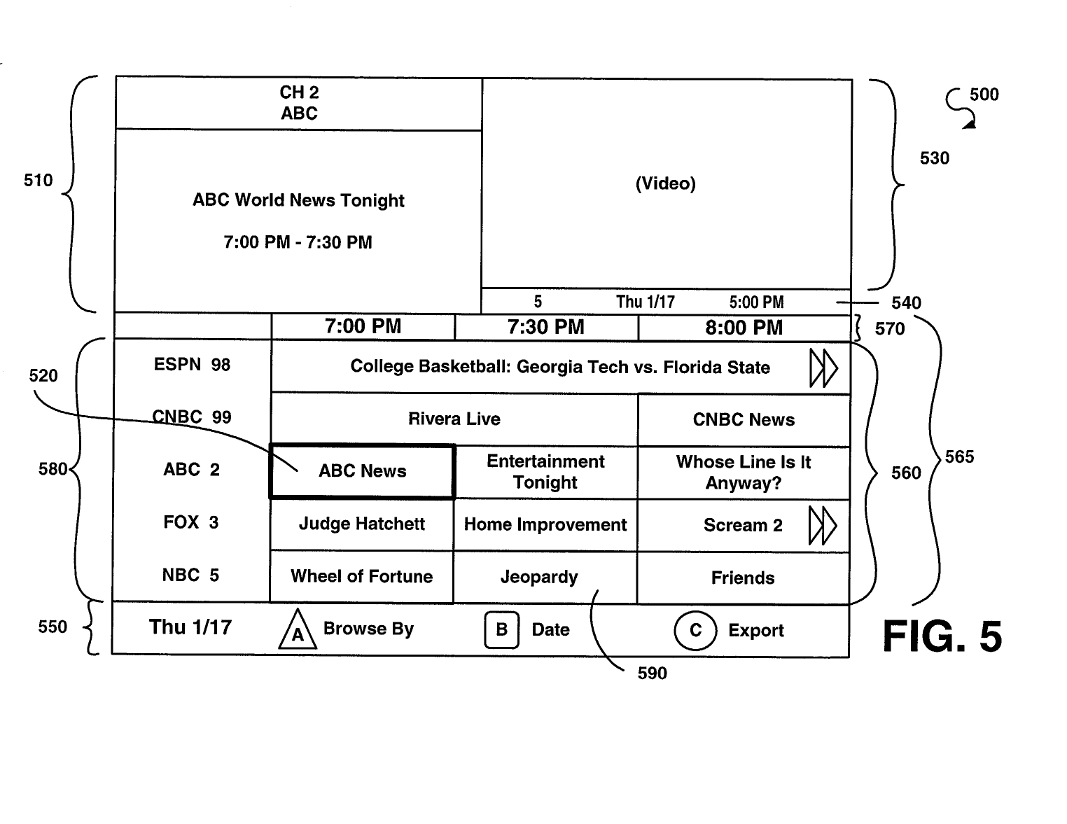

With additional reference to FIGS. 1-4 throughout the remaining figure descriptions, FIG. 5 depicts a non-limiting example of an IPG screen 500 that illustrates an initial program guide arrangement in a time format. IPG screen 500 may be presented by IPG application 224 in response to user input that is provided via, for example, the activation of the guide key 480 (FIG. 4). IPG application 224 works in cooperation with window manager 233 to present a user with IPG screens that are formatted in accordance with IPG configuration data that is stored in application memory 226. Furthermore, an IPG application 224 may retrieve television presentation information from application memory 226 as needed for presentation via an IPG screen. The top left portion of IPG screen 500 is a detailed focus area 510 that includes detailed television service information for a currently highlighted television presentation listing which, in the current example, is the ABC News listing 520. The detailed service information may include channel number, service name, television presentation name, television presentation description, television presentation duration, and/or any episode information or rating.

The television presentation occupying the full screen before the user is presented with IPG screen 500 is displayed in a video area 530. Immediately below the video area 530 is an information banner 540 for displaying the television channel number to-which the DHCT 200 is currently tuned (e.g., television channel 5), the current day and date (e.g., Thursday, January 17), and the current time (e.g., 5:00 p.m.).

An IPG grid 565 includes a television presentation listing area 560, a time listing area 570, and a service listing area 580. The television presentation listing area 560 contains a listing of television presentation titles corresponding to television presentations that are available for viewing during the time periods listed in the time listing area 570, and that are provided via respective television services identified in television service listing area 580. The television service listing area 580 includes a vertical list of television services organized sequentially from top to bottom by increasing television channel number (except for the lowest numbered television service which is typically listed immediately below the highest numbered television service). In one embodiment, the arrow buttons 410 (FIG. 4) can be used to scroll through the television presentation listing area 560 and to highlight a desired television presentation listing. The bottom area 550 of IPG screen 500 indicates the selected day for which television presentation data is being displayed as well as information about the current functions of the “A”, “B”, and “C” keys on the remote control 400.

In an alternative embodiment, an IPG screen may have fewer, additional, or different components and may have a different layout. For example, an IPG screen might not include a detailed focus area 510, a video area 530, a information banner 540, and/or a bottom area 550.

IPG data containing information about television presentations may be exported from the DHCT 200 to the client device 150, as will be discussed in more detail below. However, a person of ordinary skill in the art will understand that other DHCT-related data may also be exported from the DHCT 200 to the client device 150 within the scope of the present invention. For example, a DHCT 200 may export DHCT-related data comprising subscriber billing information, help information about using the DHCT 200, contact information for the subscriber television service provider and/or information about available DHCT services.

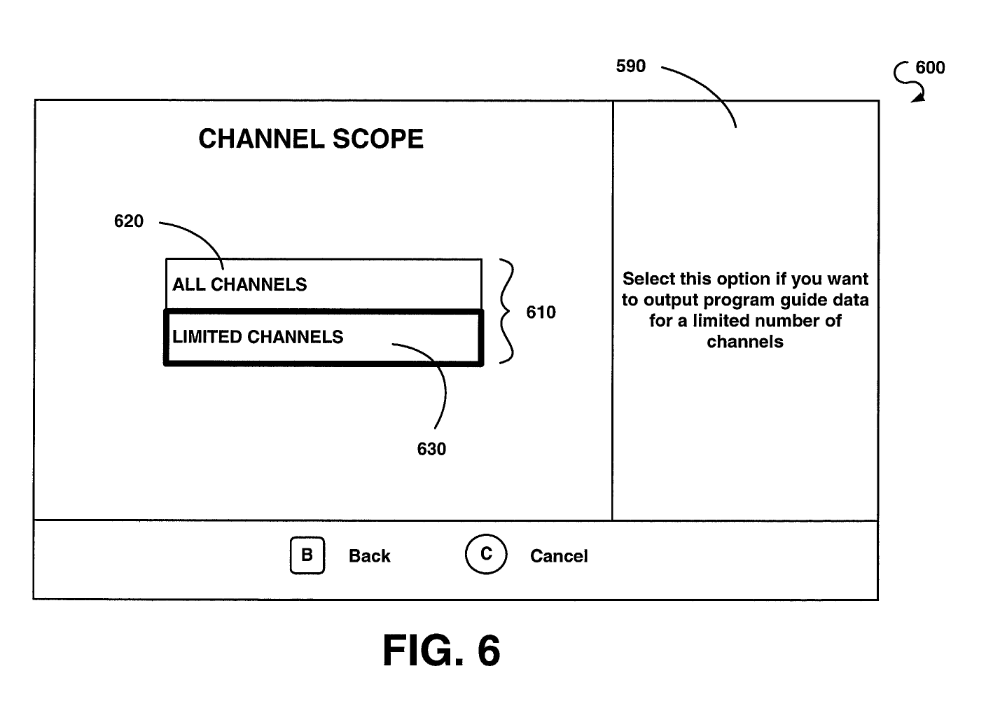

In one embodiment of the invention, the client device 150 is a printer. In this embodiment, the screens depicted in FIGS. 6-15 may be used to define and/or schedule print jobs that are to be transmitted from the DHCT 200 to the client device 150. In this manner, a user may be able to, for example, schedule a daily print job containing television program information related to the user's favorite channels.

In another embodiment of the invention, the client device 150 is a computer such as, for example, a desktop computer, a notebook computer, or a personal digital assistant (PDA). In this embodiment, the screens depicted in FIGS. 6-15 may be used to define the scope of the data that is to be exported and/or to schedule times for exporting the data. In this manner, a user may be able to, for example, view, sort, filter, and search through up-to-date program guide information using the client device 150.

FIG. 6 depicts a non-limiting example of a Channel Scope screen 600 that may be presented to a user in response to the activation of the “C” key 473 (FIG. 4). while being presented with the IPG 500 (FIG. 5). Channel Scope menu 610 includes an option 620 to export or print IPG data related to all channels and an option 630 to export or print IPG data related to a limited number of channels. In another embodiment, Channel Scope menu 610 may include additional and/or different options such as, for example, an option to export or print IPG data related to a favorite group of channels.

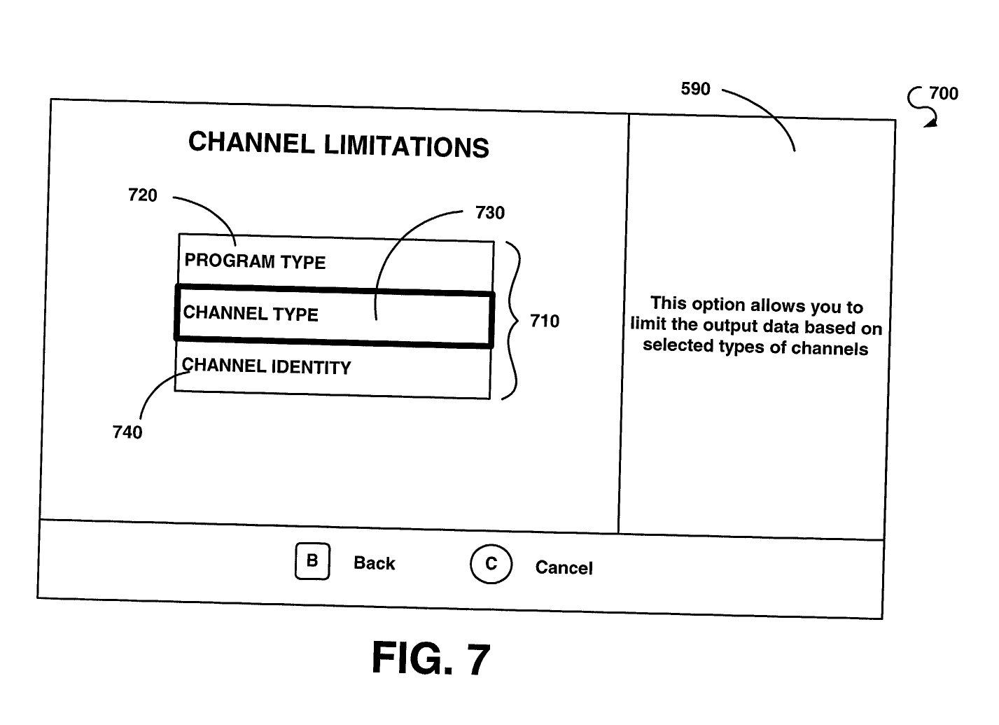

FIG. 7 depicts a non-limiting example of a Channel Limitations screen 700 that may be presented to a user in response to the selection of the option 630 to export or print IPG data related to a limited number of channels (FIG. 6). Channel Limitations menu 710 includes a program type option 720, a channel type option 730, and a channel identity option 740. The IPG configuration options 720, 730, and 740 may be used to limit the exporting or printing of IPG data based on selected television program types, television service types, and television service identities, respectively. In another embodiment, a Channel Limitations menu 710 may contain different and/or additional options such as, for example, an option to limit the exporting or printing of IPG data based on selected programs.

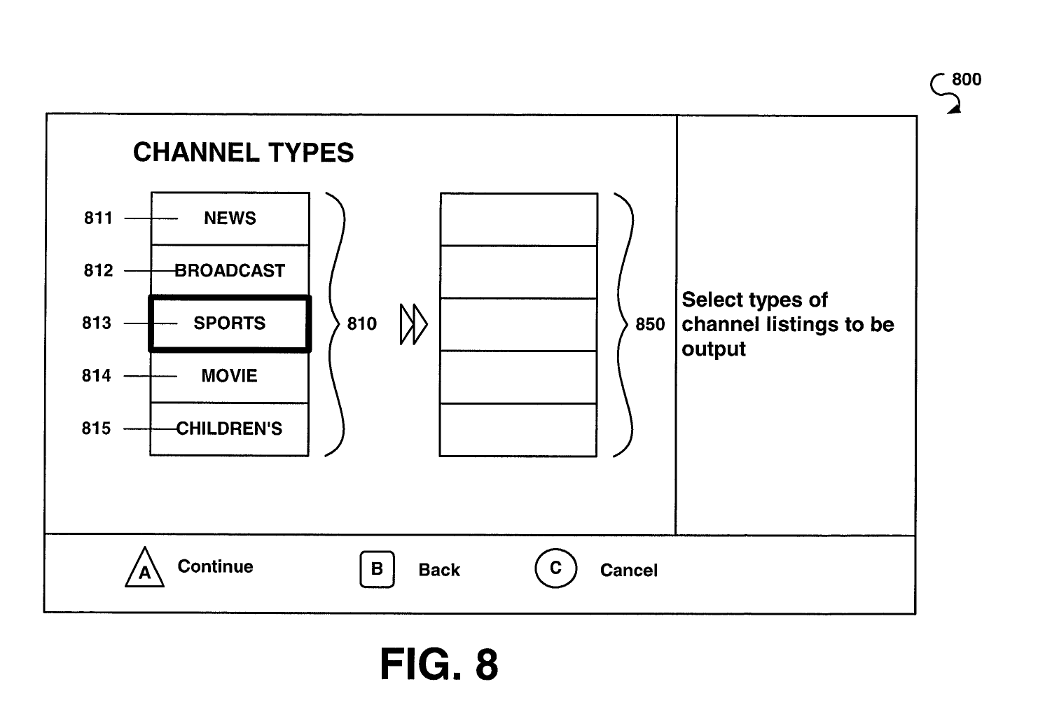

FIG. 8 depicts a non-limiting example of a channel type selection screen 800 that may be presented to a user in response to the selection of the channel type option 730 (FIG. 7). A channel type menu 810 includes a news option 811, a broadcast option 812, a sports option 813, an movie option 814, and a children's option 815. The channel type options 811-815 may be used to limit the exporting or printing of IPG data to that which corresponds to selected service type(s). A user may use the arrow keys 410 (FIG. 4) in order to access additional options by scrolling up or down the television service type menu. In another embodiment of the invention, a television service type selection screen 800 may contain different and/or additional channel type options such as, for example, music, shopping, foreign, etc. A channel type option that is selected from the television service type menu is added to an active selection list 850. After the user completes the selection process, the user can provide additional input via the remote control 400 in order to confirm the selections. Such input may be provided via, for example, activation of the “A” key 471 (FIG. 4).

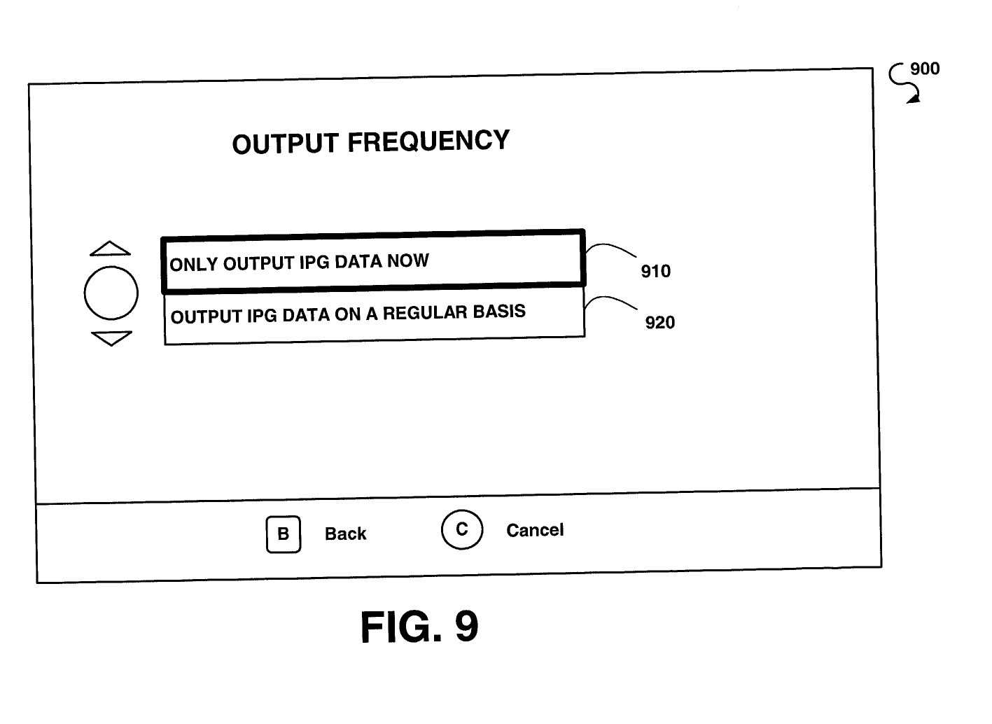

FIG. 9 depicts a non-limiting example of an Output Frequency screen 900 that may be presented to a user in response to the selection of one or more IPG data limitations such as, for example, an IPG channel type option from the IPG channel type menu 810 (FIG. 8). The Output Frequency screen 900 may also be presented in response to other user input such as for example the selection of the All Channels option 620 (FIG. 6). The Output Frequency screen 900 includes an option to “only output IPG data now” 910, and an option to “output IPG data on a regular basis” 920. These output Frequency options 910 and 920 may be used to help determine the number of times that IPG data is to be exported or printed in response to a request for exporting or printing IPG data.

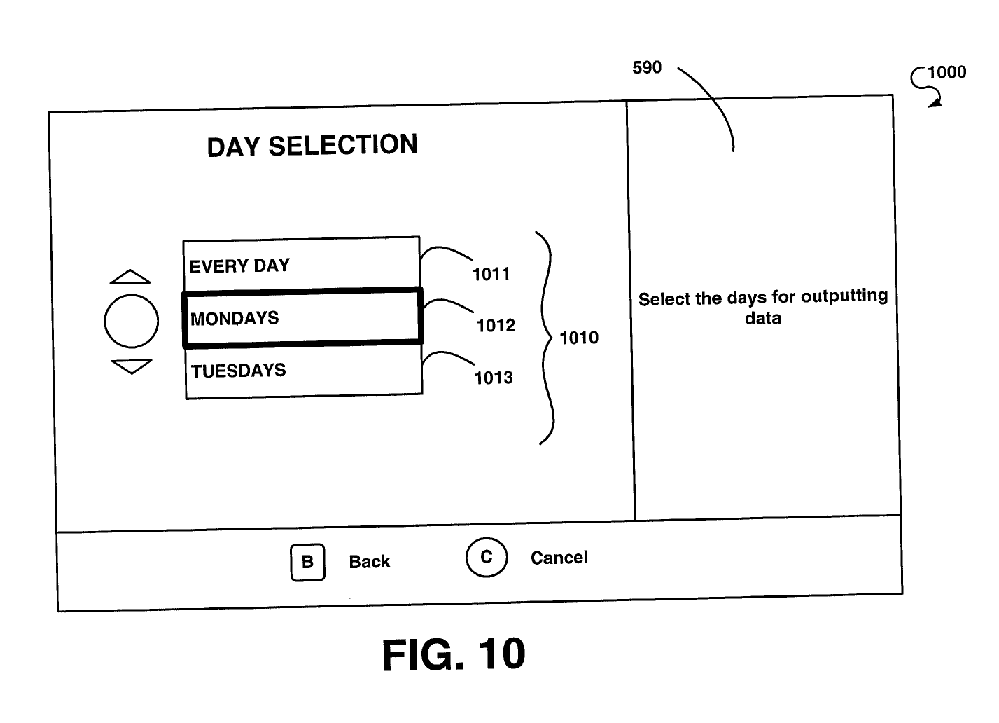

FIG. 10 depicts a non-limiting example of a day selection screen 1000 that may be presented to a user in response to the selection of option 920 from the Output Frequency to screen 900 (FIG. 9). A day selection menu 1010 includes day selection options 1011-1013 for determining days during which IPG data is to be exported or printed. In this example, day selection options include Everyday 1011, Mondays 1012 and Tuesdays 1013. A user may use the arrow keys 410 (FIG. 4) in order to access additional options by scrolling up or down the day selection menu 1010.

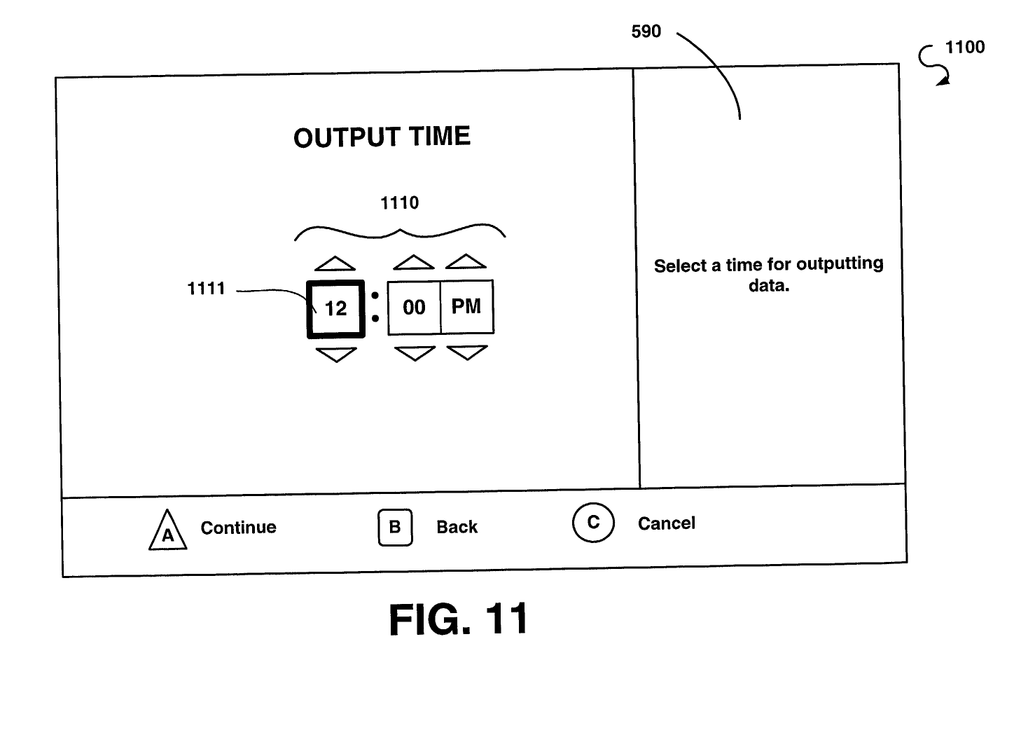

FIG. 11 depicts a non-limiting example of an export time selection screen 1100 that may be presented to a user in response to the selection of an option from the day selection screen 1000 (FIG. 10). The export time selection screen 1100 includes time selection fields 1110 for selecting a time for exporting or printing IPG data. In one embodiment, a user can use the right and left arrow keys 413 & 414 (FIG. 4) in order to highlight a selection field 1111 and the up and down arrow keys 411 & 412 (FIG. 4) in order to select a desired time. In an alternative embodiment, a user can use the number pad 450 (FIG. 4) in order to select a time for exporting or printing IPG data.

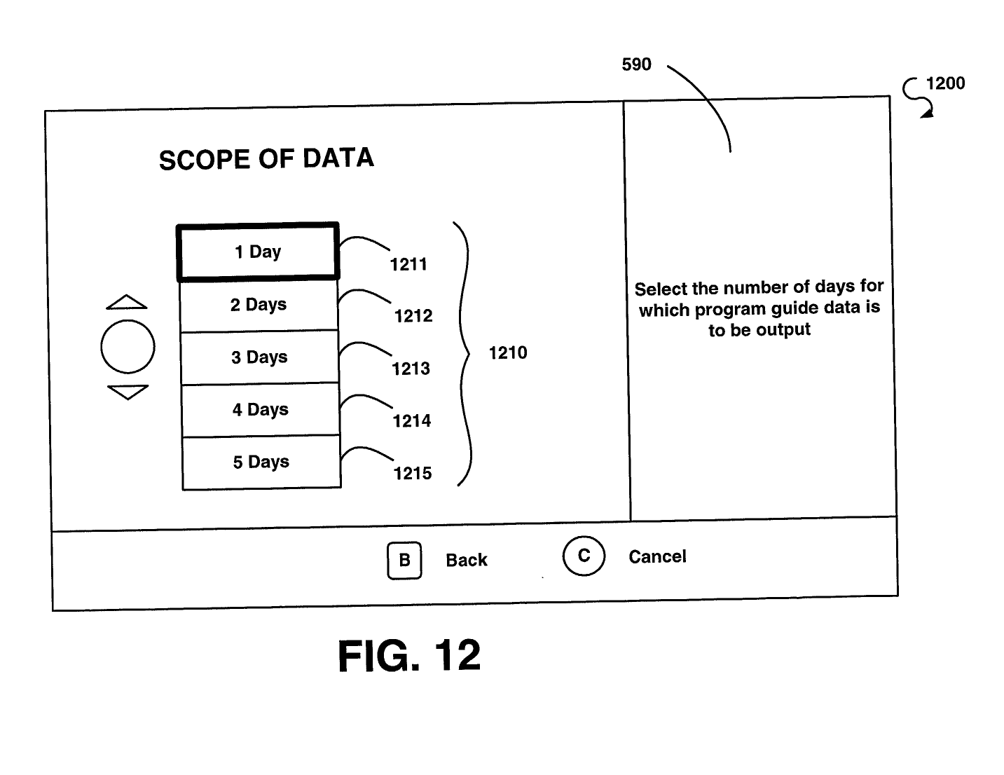

FIG. 12 depicts a non-limiting example of a scope of data selection screen 1200 that may be presented to a user in response to the selection of a data export time via the export time selection screen 1100 (FIG. 11) or in response to the selection of the “only export IPG data now” option 910 (FIG. 9). A scope of data selection menu 1210 includes scope of data options 1211-1215 that may be used to select the number of days which are to be covered by IPG data that is to be exported or printed. For example, if a user only desires to export or print IPG data corresponding to the current day, then the user would select the “1 day” option 1211. Other scope of data options shown in FIG. 12 include “2 days” 1212, “3 days” 1213, “4 days” 1214, and “5 days” 1215. In an alternative embodiment, different and/or additional scope of data options may be provided such as, for example, an option to export or print IPG data that includes television presentation information for the next 7 days.

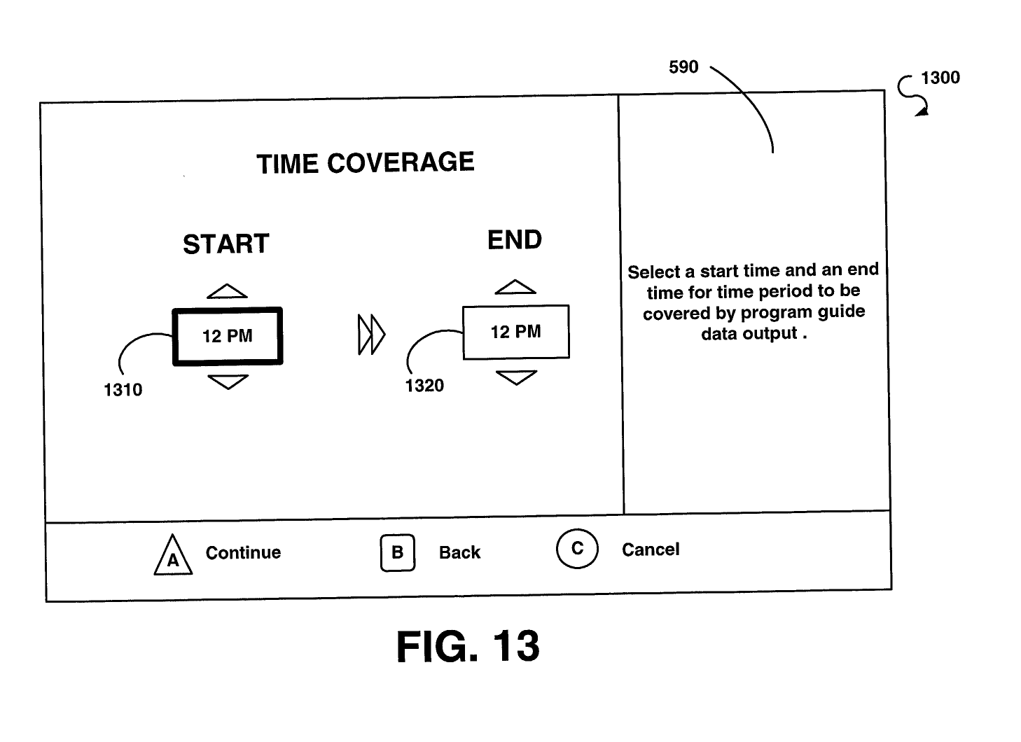

FIG. 13 depicts a non-limiting example of a Time Coverage selection screen 1300 that may be presented to a user in response to the selection of a scope of data option via the scope of data selection screen 1200 (FIG. 12). A starting time selection field 1310 and an ending time selection field 1320 may be used to specify a starting time and an ending time, respectively, for a time period that is to be covered by IPG data that is to be exported or printed. For example, a user that is only interested in watching television during the evenings may designate a start time of 7:00 p.m. and an end time of 12:00 p.m. In one embodiment, a user can use the right and left arrow keys 413 & 414 in order to highlight a selection field, the up and down arrow keys 411 & 412 in order to designate a desired time, and the select key 420 in order to select the desired time as shown in the highlighted selection field. In another embodiment of the invention, a user can use the number pad 450 (FIG. 4) in order to designate starting and ending times. In yet another embodiment, a user may select a plurality of time periods for which corresponding IPG data is to be exported or printed.

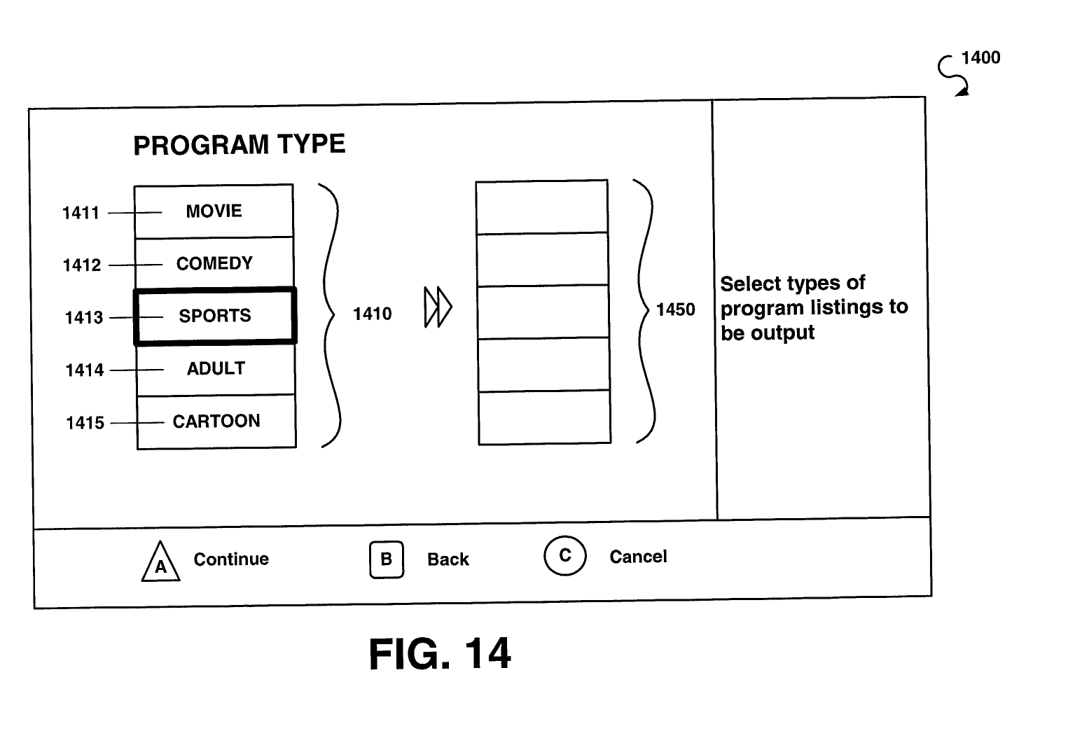

FIG. 14 depicts a non-limiting example of a program type selection screen 1400 that may be presented to a user in response to the selection of the program type option 720 (FIG. 7). Program type menu 1410 includes a movie option 1411, a comedy option 1412, a sports option 1413, an adult option 1414, and a cartoons option 1415. A user may use the arrow keys 410 (FIG. 4) in order to access additional options by scrolling up or down the program type menu. Program type options may be used to limit the exporting or printing of IPG data to that which corresponds to certain types of programs. In another embodiment, a program type selection screen 1400 may contain different and/or additional program type options such as, for example, news, drama, soap opera, etc. A program type option that is selected from the program type menu is added to an active selection list 1450. After the user selects the desired options from the program type menu 1410, the user can provide additional input (e.g., via the “A” key 471, FIG. 4) in order to confirm his or her selections.

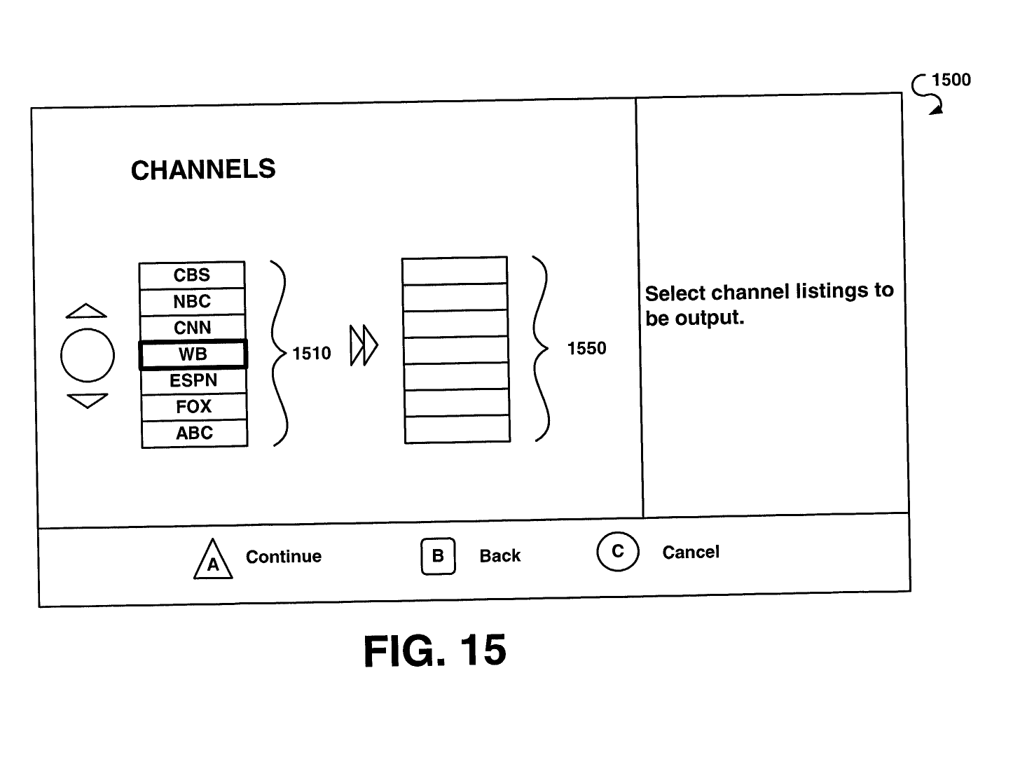

FIG. 15 depicts a non-limiting example of a channel selection screen 1500 that may be presented to a user in response to the selection of the channel identity option 740 (FIG. 7). Television service menu 1510 includes channel options that may be used to determine the television service listings that are to be included in IPG data that is to be exported or printed. A user may use the arrow keys 410 (FIG. 4) in order to access additional options by scrolling up or down the television service menu. In another embodiment, a channel selection menu 1510 may contain different and/or additional channel options such as, for example, MSNBC, BBC, ESPN2, etc. In yet another embodiment, the channels may be identified by their respective channel numbers. A channel option that is selected from the television service menu 1510 is added to an active selection list 1550. After the user adds the desired channel options to the active selection list 1550, the user can confirm his selection by, for example, activating the “A” key 471 (FIG. 4).

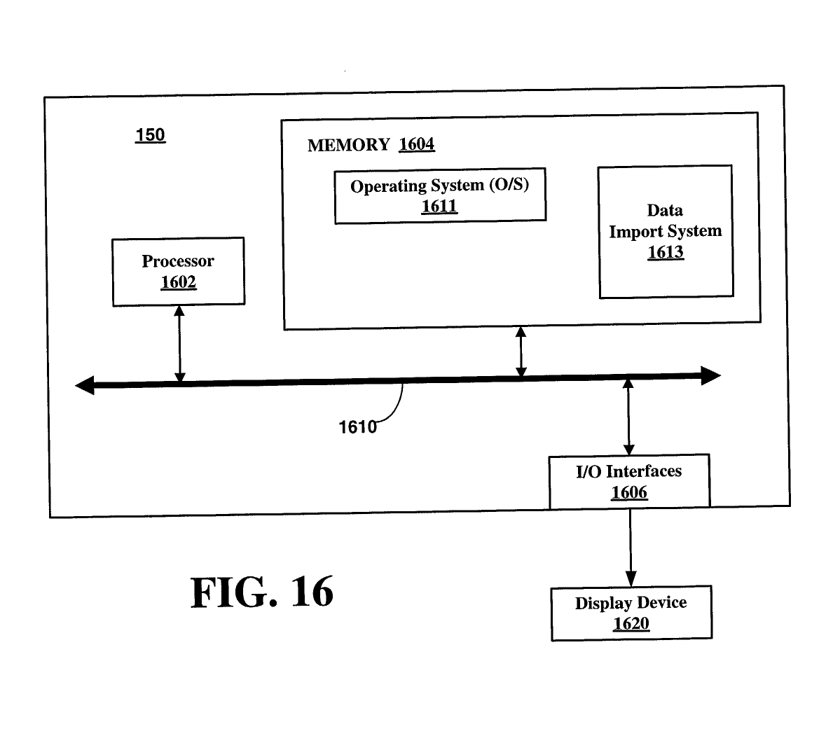

FIG. 16 is a block diagram depicting a non-limiting example of a client device 150 that can be used to import data from the DHCT 200 (FIG. 1). In this example, the client device 150 is a digital computer that, in terms of hardware architecture, generally includes a processor 1602, memory 1604, and input/output (I/O) interfaces 1606. These components (1602, 1604, and 1606) are communicatively coupled via a local interface 1610. The local interface 1610 can be, for example but not limited to, one or more buses or other wired or wireless connections, as is known in the art. The local interface 1610 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 1602 is a hardware device for executing software, particularly that stored in memory 1604. The processor 1602 can be any custom made or commercially available processor, a central processing unit (CPU), an auxiliary processor among several processors associated with the client device 150, a semiconductor-based microprocessor (in the form of a microchip or chip set), or generally any device for executing software instructions. When the client device 150 is in operation, the processor 1602 is configured to execute software stored within the memory 1604, to communicate data to and from the memory 1604, and to generally control operations of the client device 150 pursuant to the software.

The I/O interfaces 1606 may be used to receive user input from and/or to provide system output to one or more devices or components. User input may be provided via, for example, a keyboard and/or a mouse. System output may be provided via a display device 1620 and a printer (not shown). The display device 1620 may, in one implementation, be integrated into the client device 150. Communication interfaces 1606 may include, for example, a serial port, a parallel port, a Small Computer System Interface (SCSI), an IR interface, an RF interface, and/or a universal serial bus (USB) interface.

The memory 1604 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 1604 may incorporate electronic, magnetic, optical, and/or other types of storage media. Note that the memory 1604 can have a distributed architecture, where various components are situated remote from one another, but can be accessed by the processor 1602.

The software in memory 1604 may include one or more software programs, each of which comprises an ordered listing of executable instructions for implementing logical functions. In the example of FIG. 16, the software in the memory 1604 includes a data import system 1613 and a suitable operating system (O/S) 1611. The data import system 1613 may be used for importing data from a DHCT 200. In one possible embodiment, the data import system may comprise an HTML browser. The operating system 1611 essentially controls the execution of other computer programs, such as the data import system 1613, and provides scheduling, input-output control, file and data management, memory management, and communication control and related services.

If the client device 150 is a desktop computer, notebook computer, workstation, or the like, software in the memory 1604 may include a basic input output system (BIOS) (not shown). The BIOS is a set of essential software routines that initialize and test hardware at startup, start the O/S 1611, and support the transfer of data among the hardware devices. The BIOS is stored in ROM so that the BIOS can be executed when the client device 150 is activated.

The data import system 1613 may be a source program, an executable program (object code), a script, or any other entity comprising a set of instructions to be performed. When the data import system 1613 is a source program, then the data import system 1613 may be translated via a compiler, assembler, interpreter, or the like, which may or may not be included within the memory 1604, so as to operate properly in connection with the O/S 1611. Furthermore, the data import system 1613 can be written as (a) an object oriented programming language, which has classes of data and methods, or (b) a procedure programming language, which has routines, subroutines, and/or functions, such as, for example, but not limited to, C, C++, Pascal, Basic, Fortran, Cobol, Perl, Java, and Ada.

When the data import system 1613 is implemented in software, as is shown in FIG. 16, it should be noted that the data import system 1613 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The data import system 1613 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, the data import system 1613 may be implemented in hardware using, for example, any or a combination of the following technologies which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

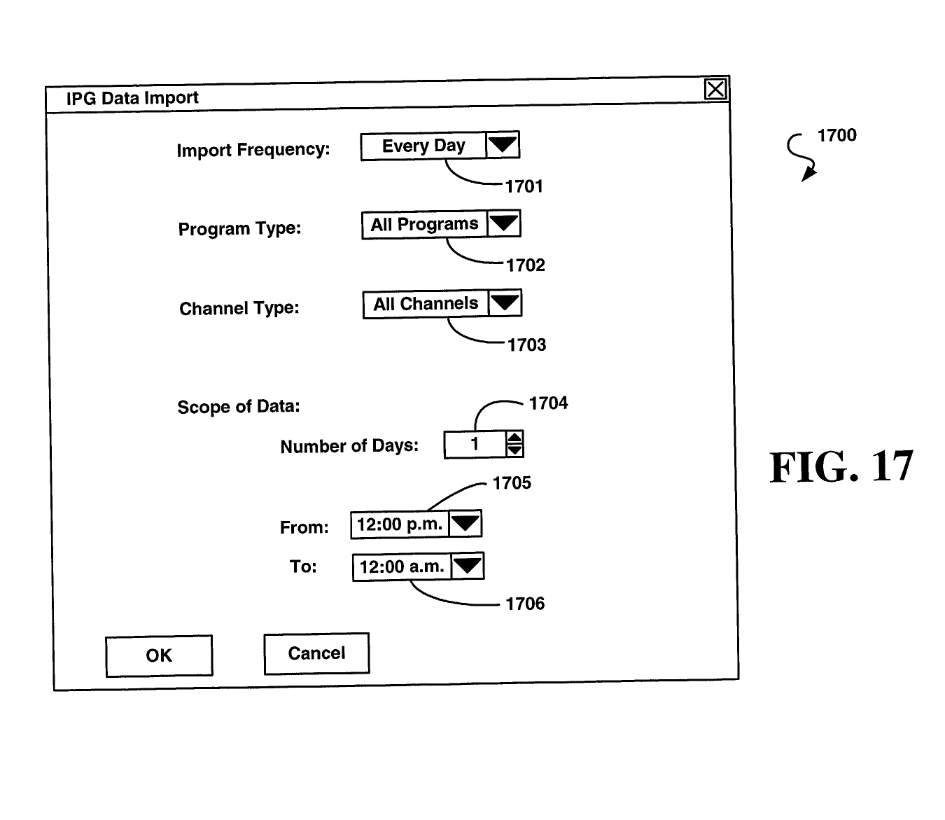

FIG. 17 depicts a non-limiting example of an IPG data import screen 1700 that may be presented to a user by the data import system 1613. The data import screen includes input fields 1701-1706 for specifying parameters related to importing data from a DHCT 200 (FIG. 1). A user may select a certain input field to view a pull-down menu associated with the selected input field and may then select an option from the input field using an input device such as, for example, a mouse or a keyboard.

In the example shown in FIG. 17, input field 1701 may be used to specify how often IPG data is to be imported from the DHCT 200. Input fields 1702-1706, on the other hand, may be used to specify the scope of the imported IPG data; fields 1702 and 1703 may be respectively used to specify the types of service listings and television presentation listings included, field 1704 may be used to specify the number of days covered, and fields 1705 and 1706 may be used to specify the beginning and end, respectively, of the desired daily time coverage. For example, the input field selections as currently shown in FIG. 17 may be used to request IPG data that is imported daily (1701), that contains information for all types of services (1702) and television presentations (1703) available via the DHCT 200, and that contains listings for 12 p.m. (1705) to 12 a.m. (1706) of only the current day (1704). In an alternative embodiment, the IPG data import screen 1700 may contain fewer, additional, and/or different components. For example, in one embodiment, the IPG data import screen 1700 may include an input field for specifying the time(s) and/or date(s) for when IPG data is to be imported.

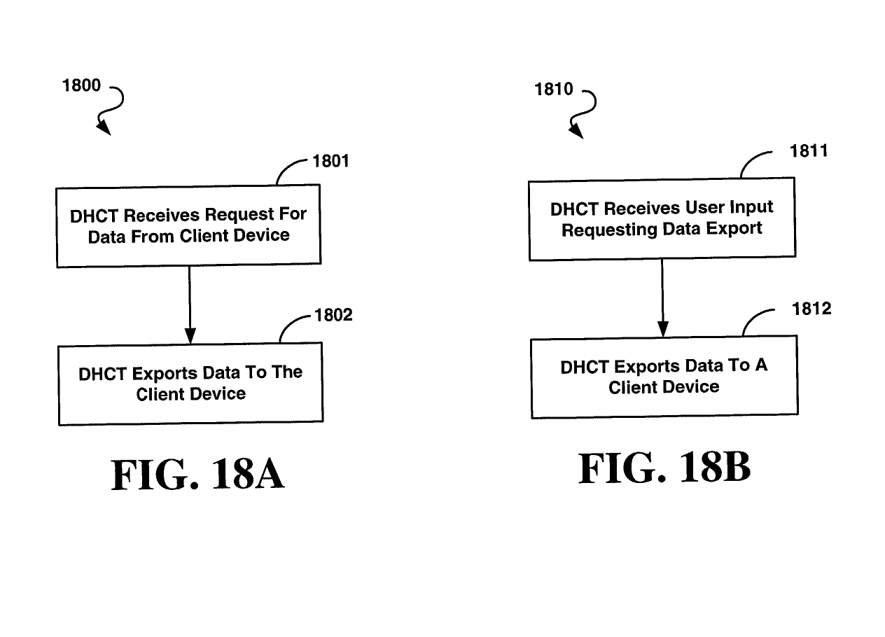

FIGS. 18A and 18B depict data export methods 1800 and 1810 for exporting data to a client device 150 (FIG. 1). In one embodiment, the data export methods 1800 and 1810 may be implemented via the data export application 225 (FIG. 2). Data export method 1800 represents a “pull model” whereby data is “pulled” from a DHCT 200 (FIG. 1), whereas data export method 1810 represents a “push model” whereby data is “pushed” to a client device 150. Using data export method 1800, a DHCT 200 receives in step 1801 a request for data from a client device 150. After receiving the request for data, the DHCT 200 exports the requested data to the client device 150, as indicated in step 1802. In contrast, using the data export method 1810, the DHCT 200 receives in step 1811 user input requesting that data be exported to a client device 150. The user input may be provided via, for example, a remote control device. After receiving the user input, the DHCT 200 exports the requested data to the client device 150, as indicated in step 1812. A DHCT 200 may be configured to support either or both of methods 1800 and 1810.

The blocks shown in FIGS. 18A and 18B represent modules, segments, or portions of code which include one or more executable instructions for implementing specific logical functions or steps in a process. The functionality provided by each of the methods illustrated in FIGS. 18A and 18B, can also be implemented through hardware (e.g., an application specific integrated circuit (ASIC) and supporting circuitry). Each implementation may have a perceived advantage, however. For example, hardware enjoys a speed and, arguably, a reliability advantage over software because hardware testing and verification methods are currently more advanced than software verification methods. On the other hand, software can be less expensive than customized hardware and offers greater flexibility in adding or modifying product features.

The functionality provided by each of the methods illustrated in FIGS. 18A and 18B, can be embodied in any computer-readable medium for use by or in connection with a computer-related system or method. In this context of this document, a computer-readable medium is an electronic, magnetic, optical, semiconductor, or other physical device or means that can contain or store a computer program or data for use by or in connection with a computer-related system or method. Also, the computer program or data may be transferred to another computer-readable medium by any suitable process such as by scanning the computer-readable medium. Thus, the computer-readable medium could be paper or other suitable medium upon which the computer program can be printed, scanned with an optical scanner, and transferred into the computer's memory or storage.

It should be emphasized that the above-described embodiments of the present invention, particularly any “preferred embodiments”, are merely possible examples, among others, of the implementations, setting forth a clear understanding of the principles of the invention. Many variations and modifications may be made to the above-described embodiments of the invention without departing substantially from the principles of the invention. All such modifications and variations are intended to be included herein within the scope of the disclosure and present invention and protected by the following claims.

What is claimed is:

1. In a system that includes a digital home communication terminal (DHCT) located at a customer premises, a method for exporting data comprising:
receiving by the DHCT a request for exporting DHCT-related data; and
exporting the DHCT-related data from the DHCT to a client device located at the customer premises.

2. The method of claim 1, further comprising:
receiving the DHCT-related data in a first format; and
formatting the DHCT-related data using a second format prior to exporting the DHCT-related data.

3. The method of claim 1, wherein the DHCT-related data is received by the DHCT from a headend.

4. The method of claim 3, wherein the headend receives a portion of the DHCT-related data from a data provider and augments the portion of the DHCT-related data with additional data.

5. The method of claim 4, wherein the data provider is a program guide provider, the DHCT-related data comprises program guide data, and the additional data comprises channel number information.

6. The method of claim 1, wherein the DHCT-related data comprises data pertaining to the DHCT.

7. The method of claim 1, wherein the DHCT-related data comprises subscriber billing information.

8. The method of claim 1, wherein the DHCT-related data comprises an instruction for operating the DHCT.

9. The method of claim 1, wherein the DHCT-related data comprises contact information for a television service provider.

10. The method of claim 1, wherein the DHCT-related data comprises information about a DHCT service.

11. The method of claim 1, wherein the DHCT-related data comprises targeted advertising information.

12. The method of claim 1, wherein the DHCT-related data comprises television program guide information.

13. The method of claim 12, wherein the television program guide information identifies a video presentation that is stored in the DHCT.

14. The method of claim 12, wherein the television program guide information identifies a television presentation that is available via the DHCT.

15. The method of claim 1, wherein the request is received from a user.

16. The method of claim 1, wherein the request is received from the client device.

17. The method of claim 1, wherein the request is received from an automated process running on the client device.

18. The method of claim 1, wherein the request is received from a cable television head-end.

19. The method of claim 1, wherein the DHCT-related data comprises data that is received by the DHCT via a cable television network.

20. The method of claim 1, wherein the DHCT-related data comprises data that is received by the DHCT via a satellite television network.

21. The method of claim 1, wherein the client device is a computer.

22. The method of claim 21, wherein the computer is one of a desktop computer a laptop computer, and a personal digital assistant (PDA).

23. The method of claim 1, wherein the DHCT-related data comprises at least one of a channel number, a date, a time of day, a viewing authorization, a program title, a program duration, a program type, a program description, a program rating, a program feature, and a program critique.

24. The method of claim 1, wherein the DHCT-related data is encoded in a Hyper Text Markup Language (HTML).

25. The method of claim 1, wherein the DHCT-related data is encoded in an Extensible Markup Language (XML).

26. The method of claim 1, wherein the DHCT-related data is encoded in a custom format for a client device application.

27. The method of claim 26, wherein the client device application is one of a word processing application, a spreadsheet application, and a database application.

28. The method of claim 1, wherein the DHCT-related data is capable of being searched by the client device.

29. The method of claim 1, wherein the DHCT-related data is capable of being queried by the client device.

30. The method of claim 1, wherein the DHCT-related data is capable of being condensed by the client device.

31. The method of claim 1, wherein the DHCT-related data comprises alphanumeric characters.

32. The method of claim 1, further comprising:
charging the user for exporting the DHCT-related data.

33. A method for exporting data from a digital home communication terminal (DHCT) to a computer, the method comprising:
receiving a message from the computer requesting television program guide data; and
exporting the television program guide data from the DHCT to the computer in response to receiving the message.

34. The method of claim 33, wherein the program guide data is stored in DHCT memory.

35. The method of claim 33, wherein the computer is one of a desktop computer, a laptop computer, and a personal digital assistant (PDA).

36. A method for transmitting data from a digital home communication terminal (DHCT) to a printer, the method comprising:
receiving a first user input identifying data to be printed;
receiving a second user input identifying a time for printing the data; and
transmitting the data to the printer at the time identified by the second user input.

37. The method of claim 36, wherein the data comprises television program guide information.

38. A digital home communication terminal (DHCT) located at a customer premises, comprising:
a communications interface for exporting DHCT-related data; and
a processor that is programmed to export the DHCT-related data via the communications interface to a client device located at the customer premises.

39. The DHCT of claim 38, wherein the DHCT-related data is received by the DHCT from a headend.

40. The DHCT of claim 39, wherein the headend receives a portion of the DHCT-related data from a data provider and augments the portion of the DHCT-related data with additional data.

41. The DHCT of claim 40, wherein the data provider is a program guide provider, the DHCT-related data comprises program guide data, and the additional data comprises channel number information.

42. The DHCT of claim 38, wherein the DHCT-related data comprises data pertaining to the DHCT.

43. The DHCT of claim 38, wherein the DHCT-related data comprises subscriber billing information.

44. The DHCT of claim 38, wherein the DHCT-related data comprises an instruction for operating the DHCT.

45. The DHCT of claim 38, wherein the DHCT-related data comprises contact information for a television service provider.

46. The DHCT of claim 38, wherein the DHCT-related data comprises information about a DHCT service.

47. The DHCT of claim 38, wherein the DHCT-related data comprises targeted advertising information.

48. The DHCT of claim 38, wherein the DHCT-related data comprises television program guide information.

49. The DHCT of claim 48, wherein the television program guide information identifies a video presentation that is stored in the DHCT.

50. The DHCT of claim 48, wherein the television program guide information identifies a television presentation that is available via the DHCT.

51. The DHCT of claim 38, wherein the request is received from a user.

52. The DHCT of claim 38, wherein the request is received from the client device.

53. The DHCT of claim 38, wherein the request is received from an automated process running on the client device.

54. The DHCT of claim 38, wherein the request is received from a cable television head-end.

55. The DHCT of claim 38, wherein the DHCT-related data comprises data that is received by the DHCT via a cable television network.

56. The DHCT of claim 38, wherein the DHCT-related data comprises data that is received by the DHCT via a satellite television network.

57. The DHCT of claim 38, wherein the client device is one of a desktop computer, a laptop computer, and a personal digital assistant (PDA).

58. The DHCT of claim 38, wherein the DHCT-related data comprises at least one of a channel number, a date, a time of day, a viewing authorization, a program title, a program duration, a program type, a program description, a program rating, a program feature, and a program critique.

59. The DHCT of claim 38, wherein the DHCT-related data is encoded in a Hyper Text Markup Language (HTML).

60. The DHCT of claim 38, wherein the DHCT-related data is encoded in an Extensible Markup Language (XML).

61. The DHCT of claim 38, wherein the DHCT-related data is encoded in a custom format for a client device application.

62. The DHCT of claim 61, wherein the client device application is one of a word processing application, a spreadsheet application, and a database application.

63. The DHCT of claim 38, wherein the DHCT-related data is capable of being searched by the client device.

64. The DHCT of claim 38, wherein the DHCT-related data is capable of being queried by the client device.

65. The DHCT of claim 38, wherein the DHCT-related data is capable of being condensed by the client device.

66. The DHCT of claim 38, wherein the DHCT-related data comprises alphanumeric characters.

67. In a system that includes a digital home communication terminal (DHCT) located at a customer premises, a method for exporting data comprising:
receiving by the DHCT program guide data that is transmitted by a headend in a first format;
transforming the program guide data having a first format into program guide data having a second format;
receiving by the DHCT a request for exporting program guide data to a computer located at the customer premises;
exporting the program guide data having the second format from the DHCT to the computer; and
wherein the headend receives a portion of the program guide data from a program guide provider and augments the portion of the program guide data with television channel number data.
